(19) United States
(12) Patent Application Publication
(10) Pub. No.: US 2025/0083050 A1
(43) Pub. Date: Mar. 13, 2025

(54) INFORMATION PROCESSING SYSTEM, STORAGE MEDIUM, INFORMATION PROCESSING DEVICE, AND GAME PROCESSING METHOD

(71) Applicant: Nintendo Co., Ltd., Kyoto (JP)

(72) Inventors: Tsubasa SAKAGUCHI, Kyoto (JP); Yusuke AMANO, Kyoto (JP); Masaki WADA, Kyoto (JP); Shinya YANO, Kyoto (JP)

(21) Appl. No.: 18/827,201

(22) Filed: Sep. 6, 2024

(30) Foreign Application Priority Data
Sep. 7, 2023 (JP) 2023-145522

(51) Int. Cl. A63F 13/63; A63F 13/56; A63F 13/69; A63F 13/847

(52) U.S. Cl. CPC A63F 13/63; A63F 13/56; A63F 13/69; A63F 13/847

(57) ABSTRACT

An exemplary information processing system causes a player character to move in a virtual game space in which a plurality of unit areas are set. The exemplary information processing system changes the states of the unit areas set in the first state to the second state, among the unit areas specified by a predetermined action performed by the player character. The exemplary information processing system updates a first parameter associated with a player, based on the number of the unit areas having been changed from the first state to the second state. The exemplary information processing system updates a second parameter, based on the number of the unit areas having been changed from the first state to the second state according to either the predetermined action performed by the player character, or the predetermined action performed by another player character corresponding to another player different from the player.

### CROSS REFERENCE TO RELATED APPLICATION

This application claims priority to Japanese Patent Application No. 2023-145522, filed on Sep. 7, 2023, the entire contents of which are incorporated herein by reference.

### FIELD

The present disclosure relates to an information processing system, a storage medium, an information processing device, and a game processing method for executing a game that is played by a plurality of players.

### BACKGROUND AND SUMMARY

Conventionally, in a game played by a plurality of players, event points are given to players playing an event game, and win/lose between teams is determined based on total points obtained by summing the event points of players who belong to the same team.

In the above game, since the event points are independently given to the players, acquisition of event points by a certain player does not cause another player to become difficult to acquire event points, for example. Therefore, it is not necessary for each player to consider another player's event point acquiring state in progressing the game, which may degrade strategic characteristics of the game regarding acquisition of event points.

Therefore, the present application discloses an information processing system, a storage medium, an information processing device, and a game processing method that can enhance the strategic characteristics of the game.

(1)

An example of an information processing system comprises one or more processors that execute information processing. The information processing comprising: causing a player character corresponding to a player to move based on an input performed by the player, in a virtual game space in which a plurality of unit areas are set, each unit area being set in either a first state or a second state; causing the player character to perform a predetermined action, based on an input performed by the player; according to the predetermined action, changing the states of the unit areas set in the first state to the second state, among the unit areas specified by the predetermined action; updating a first parameter associated with the player, based on the number of the unit areas that have been changed from the first state to the second state according to the predetermined action performed by the player character corresponding to the player;
updating a second parameter, based on the number of the unit areas that have been changed from the first state to the second state according to either the predetermined action performed by the player character, or the predetermined action performed by another player character corresponding to another player different from the player; executing a first process based on the first parameter; and executing a second process based on the second parameter.

According to the configuration of the above (1), the player aims for update of the first parameter while considering the states of unit areas having been changed by another player, whereby the strategic characteristics of the game can be enhanced.

(2)

In configuration (1) above, the first process may be giving a first reward to the player, based on a value of the first parameter.

According to the configuration of the above (2), giving the first reward motivates the player to progress the game by changing the states of the unit areas.

(3)

In configuration (2) above, the first reward may be a right for the player to acquire a predetermined item.

According to the configuration of the above (3), it is possible to motivate the player to progress the game.

(4)

In configuration (3) above, the first process may be giving the right to the player such that more types of rights are given in a case where the value of the first parameter is large than in a case where the value of the first parameter is small.

According to the configuration of the above (4), it is possible to more strongly motivate the player to play the game.

(5)

In any one of configurations (1) to (4) above, the game space may include a plurality of sections. Each section may include a plurality of unit areas. The second parameter may be associated with each section. In updating the second parameter, the second parameter associated with the section including the unit areas having been changed from the first state to the second state may be updated.

According to the configuration of the above (5), the second parameter can be set for each section.

(6)

In configuration (5) above, the information processing may further comprise executing a third process related to the section, based on an input performed by the player. The second process may be a process of restricting execution of the third process related to the section associated with the second parameter if the second parameter does not satisfy a release condition, and releasing the restriction on the execution of the third process if the second parameter satisfies the release condition.

According to the configuration of the above (6), it is possible to motivate the player to progress the game by changing the states of the unit areas.

(7)

In configuration (6) above, the third process may be a process of moving the player character to other sections adjacent to the section. The second process may be a process of, based on the second parameter, releasing the restriction on the execution of the third process of moving the player character to other sections adjacent to the section associated with the second parameter.

According to the configuration of the above (7), motivation to progress the game can be given to the player who desires to move the player character to another section.

(8)

In configuration (7) above, the second process may include, if the second parameter satisfies the release condition, changing the unit areas in the first state, included in the section associated with the second parameter, to the second state.

According to the configuration of the above (8), it is possible to reduce the risk that the game does not smoothly progress under the situation where the number of unit areas in the second state is increased in the section.

(9)

In configuration (8) above, the release condition may be that the second parameter becomes a value at which more than half of the unit areas included in the section are in the second state.

According to the configuration of the above (9), it is possible to reduce the risk that the game does not progress smoothly.

(10)

In any one of configurations (5) to (9) above, updating the first parameter may be an update in which, in response to that the unit areas have been changed from the first state to the second state according to the predetermined action, the first parameter is increased based on the number of the changed unit areas. The first process may be executed when the first parameter has reached a predetermined value. In updating the first parameter, an amount of increase in the first parameter in response to that the unit areas have been changed from the first state to the second state may be larger in a case where the number of unit areas in the second state is large in the section than in a case where the number of unit areas in the second state is small in the section.

According to the configuration of the above (10), it is possible to more strongly motivate the player to progress the game under the situation where the number of unit areas in the second state is increased in the section.

(11)

In any one of configurations (5) to (10) above, updating the second parameter may be an update in which, in response to that the unit areas have been changed from the first state to the second state according to the predetermined action, the second parameter is increased based on the number of the changed unit areas. The second process may be executed when the second parameter has reached a predetermined value. In updating the second parameter, an amount of increase in the second parameter in response to that the unit areas have been changed from the first state to the second state may be larger in a case where the number of unit areas in the second state is large in the section than in a case where the number of unit areas in the second state is small in the section.

According to the configuration of the above (11), it is possible to more strongly motivate the player to progress the game under the situation where the number of unit areas in the second state is increased in the section.

(12)

In any one of configurations (1) to (12) above, changing the unit areas to the second state may be changing the states of the unit areas being set in the first state, irreversibly to the second state.

According to the configuration of the above (12), it is possible to reduce the risk that the number of unit areas in the second state is not increased and the game is not progressed.

(13)

In any one of configurations (1) to (12) above, updating the first parameter may include, in a case where the unit areas located within a predetermined range based on the player character corresponding to the player are changed from the first state to the second state according to the predetermined action performed by the player character, further updating the first parameter associated with the player.

According to the configuration of the above (13), since the chances of updating the first parameter can be increased, it is possible to motivate each player to progress the game.

(14)

In configuration (13) above, updating the first parameter may include, in a case where the unit areas located within the predetermined range based on the player character corresponding to the player are changed from the first state to the second state according to the predetermined action performed by the another player character, updating the first parameter associated with the player, based on the number of the changed unit areas.

According to the configuration of the above (14), it is possible to reduce the risk that the players feel unfair regarding update of the first parameter.

(15)

In any one of configurations (1) to (14) above, the information processing may further include, in response to that the unit areas have been changed from the first state to the second state, displaying images as many as the number of the changed unit areas such that the images move from the positions corresponding to the unit areas toward the player character.

According to the configuration of the above (15), the player can be notified of the number of unit areas changed to the second state in an easily understandable manner. Also, the player can be notified of the player character whose first parameter is updated.

(16)

In any one of configurations (1) to (15) above, the information processing may further comprise, if a presentation condition related to the second parameter is satisfied by update of the second parameter, presenting, to the another player, information on the player corresponding to the player character having performed the predetermined action that is a cause of the update.

According to the configuration of the above (16), it is possible to motivate the player to progress the game by changing the states of the unit areas.

(17)

In any one of configurations (1) to (16) above, the information processing may further comprise, if a granting condition related to the second parameter is satisfied by update of the second parameter, giving a second reward to the player corresponding to the player character having performed the predetermined action that is a cause of the update.

According to the configuration of the above (17), it is possible to motivate the player to progress the game by changing the states of the unit areas.

(18)

In any one of configurations (1) to (17) above, in changing the states of the unit areas to the second state, if the unit areas specified by the predetermined action are located within a range based on a position of a first object, changing the states of at least of a part of the unit areas to the second state may be restricted.

According to the configuration of the above (18), the strategic characteristics of the game can be improved.

(19)

In any one of configurations (1) to (18) above, the predetermined action may be an action of the player character to place a second object in a unit area. Changing the states of the unit areas to the second state may be changing the unit areas within a predetermined range including the unit area in which the second object is placed, to the second state.

According to the configuration of the above (19), since the unit areas are changed to the second state by the action of placing the object, the player can easily recognize the position where the action was performed.

In the present specification, an example of an information processing device including the components described in the above (1) to (19) is disclosed. In addition, in the present specification, an example of a storage medium having stored therein a game program that causes a computer of an information processing device to execute the processes described in the above (1) to (19), is disclosed. Moreover, in the present specification, an example of an information processing method for executing the processes in the above (1) to (19) is disclosed.

According to the information processing system, the storage medium, the information processing device, and the game processing method, the strategic characteristics of the game can be enhanced.

These and other objects, features, aspects and advantages of the exemplary embodiment will become more apparent from the following detailed description when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a block diagram showing an example of a configuration in which a game system shown in FIG. 1 is communicably connected with a server;

FIG. 9 is a block diagram showing an example of a configuration of a non-limiting server;

FIG. 10 shows an example of a game image displayed in a non-limiting game system;

FIG. 11 shows an example of a state where a player character places an antenna object in a game field;

FIG. 12 shows an example of a game field divided into a plurality of sections;

FIG. 13 shows an example of a development state in one section;

FIG. 14 shows an example of a game image after an antenna object has been placed;

FIG. 15 shows an example of various data stored in a non-limiting game system;

FIG. 16 is a flowchart showing an example of a flow of a terminal process executed by a non-limiting game system;

FIG. 17 is a sub-flowchart showing an example of a specific flow of a player-related control process in step S2 shown in FIG. 16;

FIG. 18 is a flowchart showing an example of a flow of a server process executed by a non-limiting server; and

FIG. 19 is a sub-flowchart showing an example of a specific flow of a development value process in step S58 shown in FIG. 18.

### DETAILED DESCRIPTION OF NON-LIMITING EXAMPLE EMBODIMENTS

### 1. Configuration of Game System

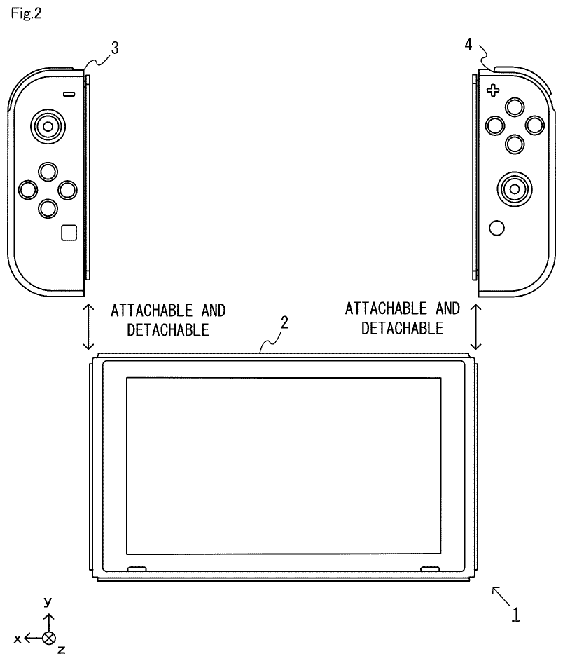

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

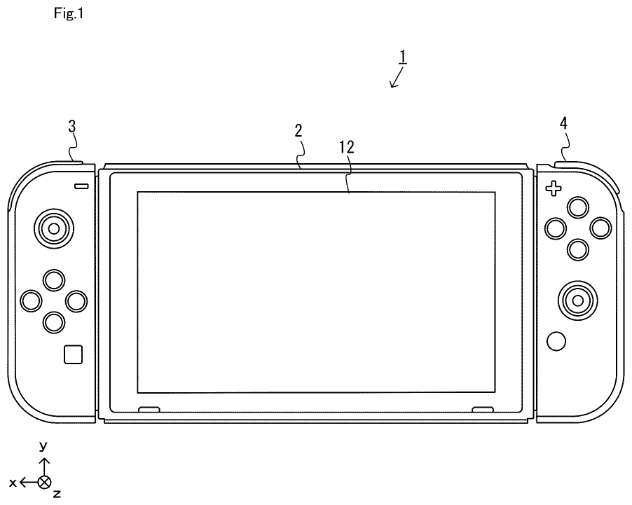

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

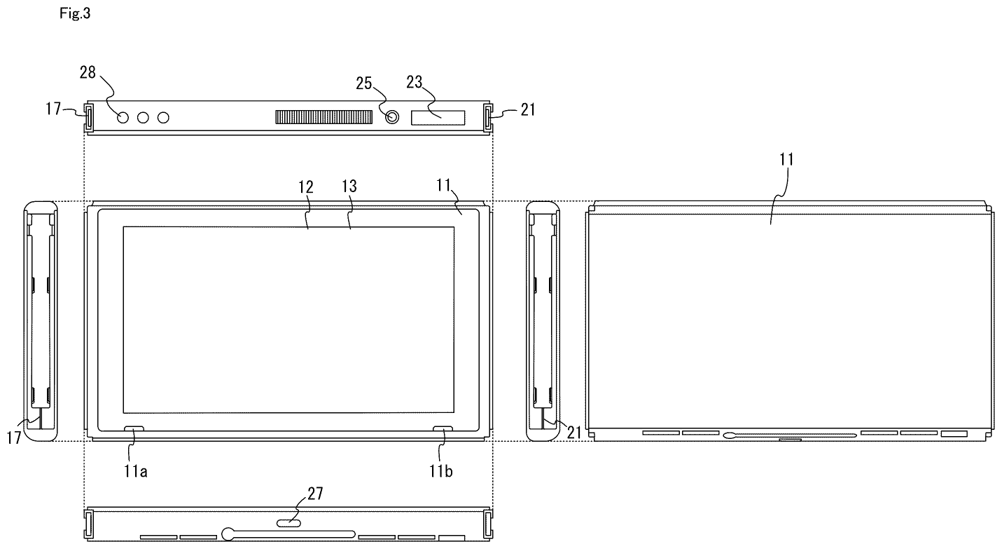

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

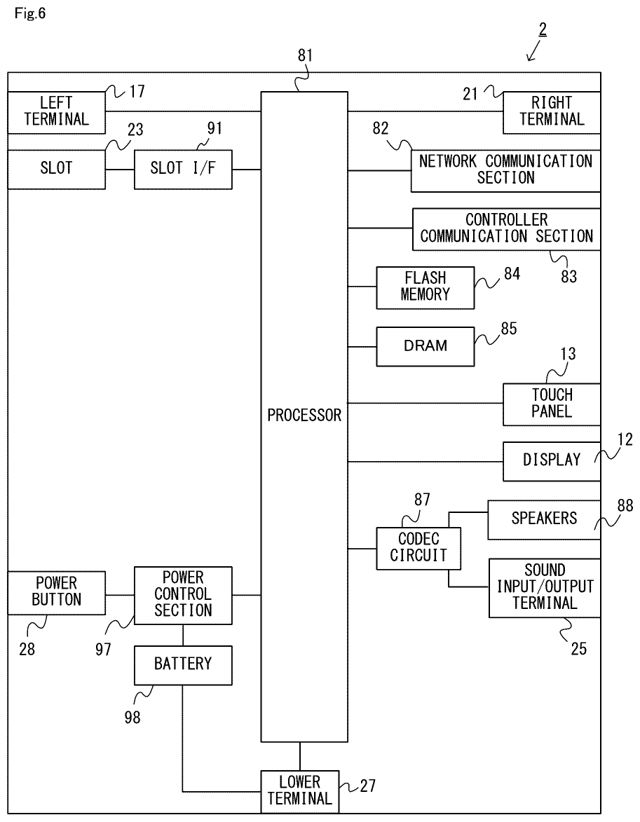

The main body apparatus 2 includes speakers (i.e., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and output from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

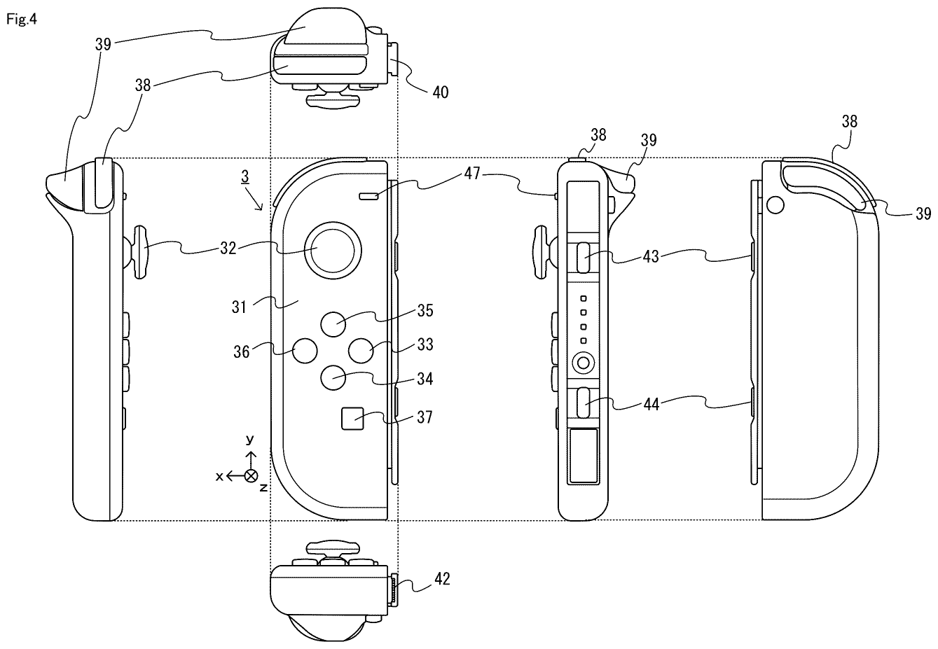

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction (i.e., a y-axis direction shown in FIGS. 1 and 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

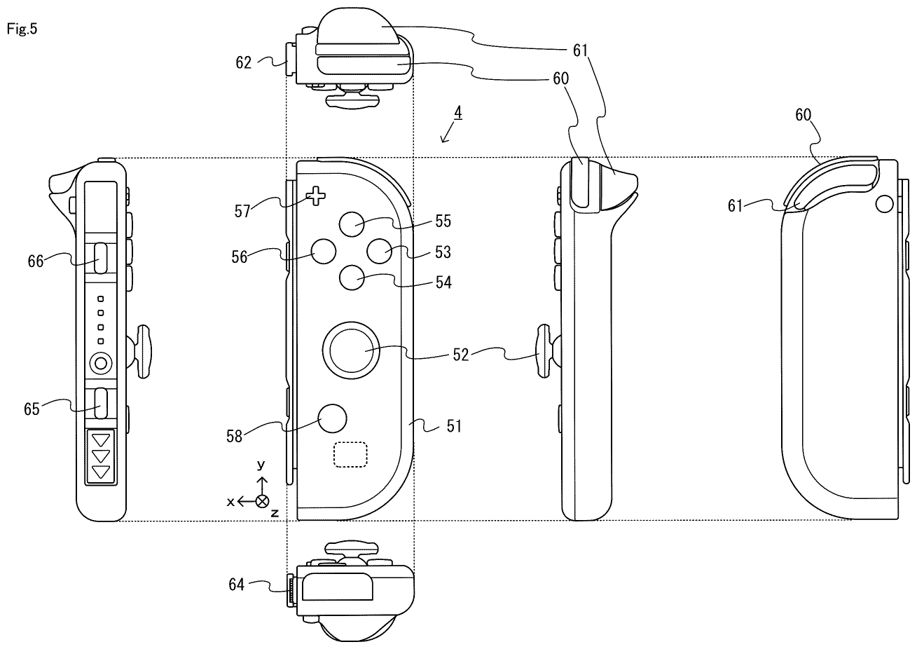

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

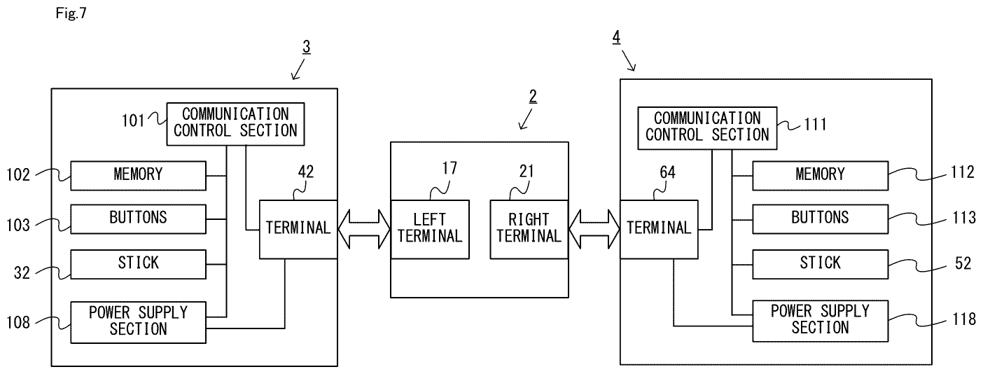

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### 2. Configuration of Information Processing System

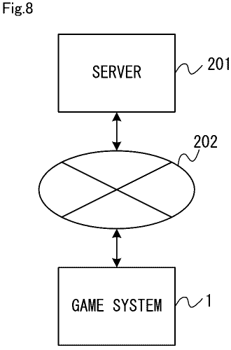

FIG. 8 is a block diagram showing an example of an information processing system including the game system 1 shown in FIG. 1. As shown in FIG. 8, the information processing system according to the exemplary embodiment includes a plurality of game systems, each corresponding to the aforementioned game system 1, to be used by different users (FIG. 8 exemplarily shows only one game system 1). The plurality of game systems included in the information processing system may include an information processing device of a different type from the game system 1.

As shown in FIG. 8, the information processing system includes a server 201 communicable with each game system. In the exemplary embodiment, the game system 1 and the server 201 are connectable to a network 202 such as the Internet and/or a mobile communication network. The game system 1 and the server 201 are communicable with each other via the network 202. In addition, the respective game systems are communicable with each other via the network 202.

In this specification, the “server” means one information processing device (i.e., server device). When the function of the server is implemented by a plurality of server devices, the “server” means the entirety of a server device group (i.e., a server system). That is, the “server” may be a server device or a server system. If a plurality of information processing devices are included in the server system, these information processing devices may be located in the same place or different places. The hardware configuration of the server 201 in the exemplary embodiment may be the same as that for the conventional server.

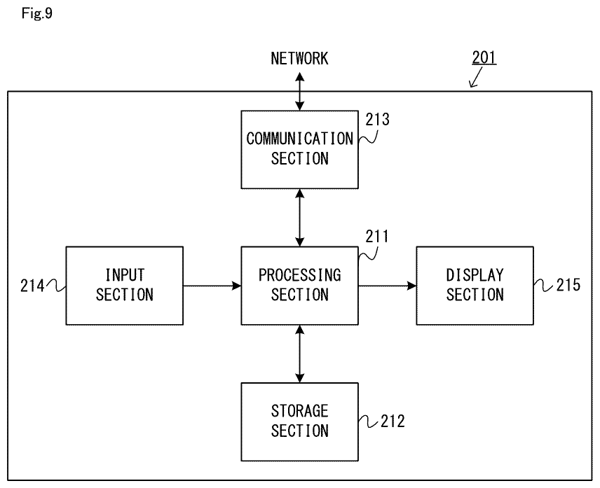

FIG. 9 is a block diagram showing an example of the configuration of the server 201. The constituents included in the server 201 shown in FIG. 9 are implemented by one or more information processing devices. As shown in FIG. 9, the server 201 includes a processing section 211 and a storage section 212. The processing section 211 is electrically connected to the components 212 to 215 of the server 201. The processing section 211 includes a CPU (Central Processing Unit, in other words, processor) and a memory. In the server 201, the CPU executes, using the memory, programs stored in the storage section 212, thereby executing various kinds of information processing. The storage section 212 is any storage device (also referred to as “storage medium”) that is accessible to the processing section 211. The storage section 212 stores therein programs to be executed in the processing section 211, data to be used for information processing by the processing section 211, data obtained through the information processing, etc. In the exemplary embodiment, the storage section 212 stores therein at least a program for game processing that is executed on the server side for game processing to be executed in the game system 1.

The server 201 includes a communication section 213. The communication section 213 is connected to the network 202, and has a function of communicating with other devices (e.g., the game system 1) via the network 202. The processing section 211 transmits information to the other devices and receives information from the other devices by using the communication section 213. The server 201 further includes an input section 214 and a display section 215 as input/output interfaces.

### 3. Outline of Processing in Information Processing System

Hereinafter, the outline of game processing executed in the information processing system will be described. In the exemplary embodiment, the information processing system executes game processing for a game in which a plurality of players (in other words, users) operate their player characters in a virtual game space. In the exemplary embodiment, the game is a game for developing a game field in the game space. Each player plays the game for one purpose of increasing the number of developed areas in the game field by operating his/her player character.

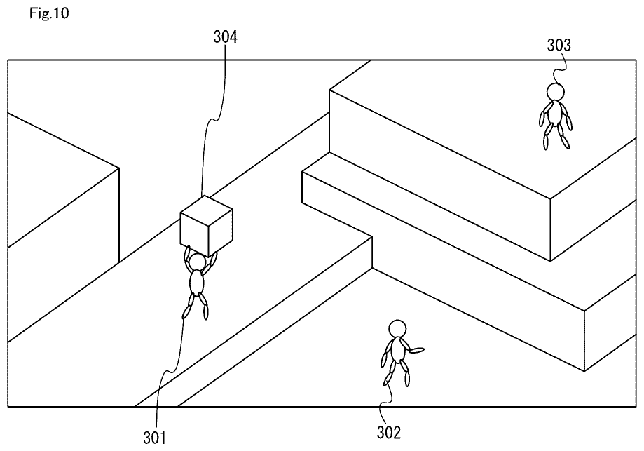

FIG. 10 shows an example of a game image displayed in the information processing system according to the exemplary embodiment. As shown in FIG. 10, the game system 1 displays, on the display 12, a game image showing a game field in which a player character 301 is placed. For example, the game system 1 generates a game image such that the game image includes the player character 301 that is operated by the player of the game system 1. As shown in FIG. 10, in the game image, other player characters (in FIG. 10, other player characters 302 and 303) that are operated by other players may be displayed in addition to the player character 301.

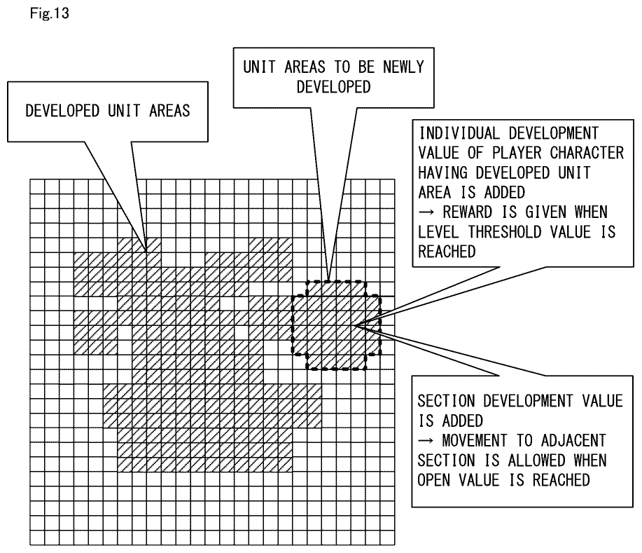

In the exemplary embodiment, the game field is composed of a plurality of unit areas. For example, the unit areas are areas obtained by dividing the game field into square lattices as viewed in the vertical direction (see FIG. 13 described later). Specifically, assuming that an x axis and a z axis are set in parallel to the horizontal direction in the game field and a y axis is set in parallel to the vertical direction in the game field, one area, which is demarcated in a square shape by a plurality of planes parallel to an xy plane and a plurality of planes parallel to a yz plane, is a unit area. The respective unit areas have the same size. Thus, the game field is configured such that the unit areas are arranged in the horizontal direction (specifically, front-rear direction and left-right direction) in the game space.

In the exemplary embodiment, the game field takes, for each unit area, either an “undeveloped” state or a “developed” state. In the exemplary embodiment, in the initial state of the game, all the unit areas in the game field are set in the “undeveloped” states. In other embodiments, the game field may take another state in addition to the above two states. In other embodiments, the undeveloped state may be divided into a plurality of stages and managed, and the developed state may be divided into a plurality of stages and managed.

In the exemplary embodiment, the shape of the game field can be changed. Here, in the exemplary embodiment, the components constituting the game field are referred to as “pieces”. The player character can change the shape of the game field by moving a part of the game field in units of pieces. One piece is a cube having a size in the horizontal direction corresponding to the size of one unit area 1, and a length in the vertical direction being equal to a length of one unit area in the horizontal direction. The game image shown in FIG. 10 represents a state in which the player character 301 is moving one piece 204. Although the player character 301 is moving one piece 204 in FIG. 10, the player character 301 can move a plurality of pieces together in the exemplary embodiment.

As described above, in the exemplary embodiment, the player character can edit the game field. The player character may be able to delete a piece and add a new piece, as editing to the game field.

In the exemplary embodiment, the player character can perform an action of placing an antenna object in the game field, based on an operation input performed by the player. If an antenna object is placed, the information processing system sets unit areas within a predetermined influence range including a unit area where the antenna object is placed, to the developed states. Specifically, a unit area, which has already been set in the developed state in the influence range, is maintained in the developed state, while a unit area, which is in the undeveloped state in the influence range, is changed to the developed state. As described above, in the exemplary embodiment, the player character can expand the developed area by placing an antenna object in the game field. Thus, each player can check the position where the action for development has been performed by visually recognizing the antenna object.

An action for setting a unit area to the developed state is discretionary, and is not limited to the action of placing an antenna object. For example, in other embodiments, a unit area may be changed to the developed state according to an action of the player character using a predetermined item. In the exemplary embodiment, the player character can place an antenna object at any position in the game field. In other embodiments, the position where an antenna object can be placed in the game field may be limited.

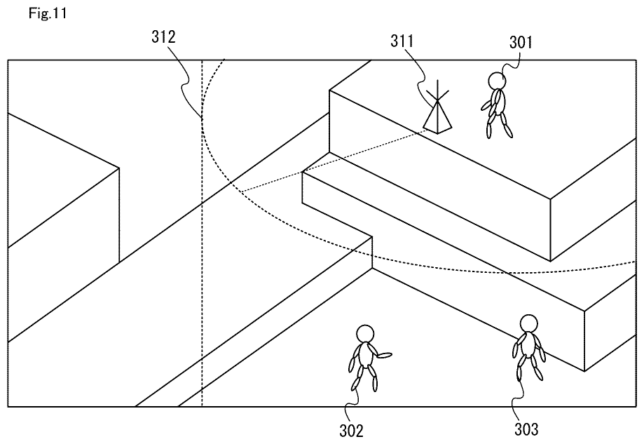

FIG. 11 shows an example of a state where a player character places an antenna object in the game field. In the exemplary embodiment, if an antenna object 311 is placed, the information processing system sets an influence range 312 based on the position of the placed antenna object 311. In the exemplary embodiment, the influence range 312 is a columnar region centering around the antenna object 311 (see FIG. 11). The height of the influence range 312 is set to be infinite, for example. Alternatively, the influence range 312, on the side lower than the antenna object 311, may have a columnar shape extending infinitely downward from the position of the antenna object, while the influence range 312, on the side higher than the antenna object 311, may have a semispherical shape centering around the position of the antenna object 311 and having the same radius as the columnar shape. In other embodiments, the influence range may have any shape, and may have a shape (e.g., a sphere or a cube) other than a column. The game system 1 may or may not display the image representing the influence range 312.

In the exemplary embodiment, the information processing system changes the size of the influence range 312 according to the position where the antenna object 311 is placed. Specifically, the size of the influence range 312 is set to be larger with an increase in the height of the antenna object 311. More specifically, the information processing system sets the radius of the column of the influence range 312 such that the radius is proportional to the height of the position where the antenna object 311 is placed. Therefore, in the exemplary embodiment, the player can make the influence range 312 larger by placing the antenna object 311 at the higher position, thereby setting more unit areas to the developed states. For example, the player may change the shape of the game field such that a part of the game field is extended upward, and place the antenna object 311 at the top of the extended part, thereby increasing the influence range 312. The influence range setting method based on the position where an antenna object is placed is discretionary. For example, in other embodiments, the information processing system may set an influence range to a uniform size regardless of the height of the position where an antenna object is placed.

In the exemplary embodiment, the player character can perform a predetermined special action by consuming energy based on an operation input performed by the player. If the energy of the player character is less than the amount of energy required for the special action, the player character cannot perform the special action. The special action may be any action that can advantageously progress the game. For example, the special action may be an action of moving in the game field at a higher speed than usual by using a support item described later, or may be an action of moving more pieces together than usual (i.e., a case using no support item). The amount of energy to be consumed by the special action may be set according to the type of the special action.

The consumption of energy for the special action performed by the player character is smaller in the case where the player character is located inside the influence range than in the case where the player character is located outside the influence range (that is, the consumption in the case where the player character is located inside the influence range may be 0). Therefore, in the exemplary embodiment, setting an antenna object allows the player character to easily perform the special action in the influence range, and allows the player character to advantageously perform an action in the influence range.

In the exemplary embodiment, as for an influence range based on an antenna object placed by a player character, the information processing system restricts editing of the game field by another player character different from the player character. That is, by placing the antenna object, the player character can inhibit the another player character from performing editing in the influence range caused by the antenna object.

The information processing system may prepare a plurality of types of antenna objects, and may set different conditions for player characters that are restricted from performing editing in influence ranges due to the antenna objects, depending on the types of the antenna objects. For example, the information processing system may allow each player object to place a first type antenna object, a second type antenna object, and a third type antenna object. The first type antenna object can restrict editing by all player characters other than a player character that has placed this antenna object. The second type antenna object can restrict editing by other player characters excluding player characters belonging to the same group as a player character that has placed this antenna object. The third type antenna object does not restrict editing by any player characters. The information processing system may set the number of antenna objects that one player character can place, for each type of antenna object.

As described above, in the exemplary embodiment, placing an antenna object allows each player to enjoy an advantage of reducing the consumption of energy due to the special action in the influence range, and an advantage of restricting editing in the influence range by another player character, in addition to the advantage that the game field in the influence range can be set to the developed state. Thus, it is possible to motivate the player to place an antenna object, thereby promoting development of the game field. The advantages achieved by placing an antenna object are not limited to those described above. For example, in other embodiments, the information processing system may not necessarily provide the player with at least one of the advantage of reducing the consumption of energy due to the special action in the influence range, and the advantage of restricting editing in the influence range by another player character. Moreover, in other embodiments, placing an antenna object may provide the player with an advantage different from the above advantages. For example, the energy of the player character may be increased according to the number of unit areas having been changed to the developed states.

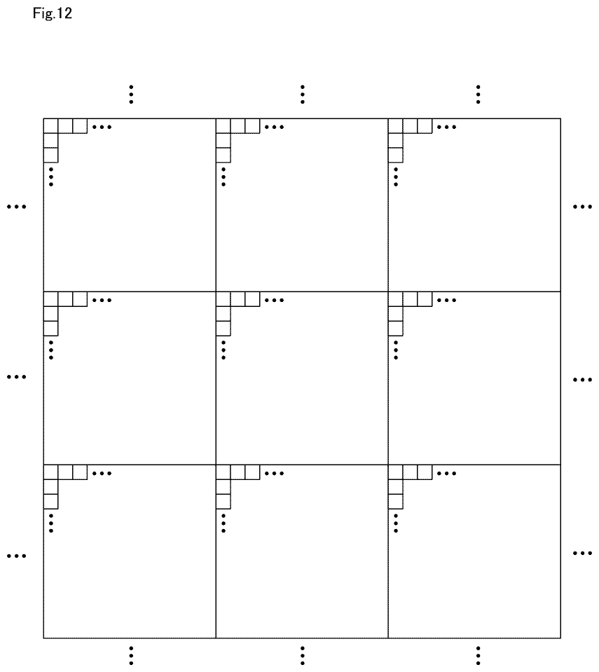

In the exemplary embodiment, the game field is divided into a plurality of sections. FIG. 12 shows an example of a game field divided into a plurality of sections. FIG. 12 schematically shows the game field as viewed from above. In FIG. 12, small squares represent unit areas, and large squares represent sections.

As shown in FIG. 12, one section is composed of a plurality of unit areas. In the exemplary embodiment, the game field is not divided into a plurality of sections in the vertical direction. However, in other embodiments, the game field may be divided into a plurality of sections even in the vertical direction. In the exemplary embodiment, the sections have the same size (i.e., the same number of unit areas). However, in other embodiments, the sections may have different sizes.

Although described in detail later, in the exemplary embodiment, when a certain number or more of unit areas, among the unit areas including in one section, have been set in the developed states, this section is set in the development completed state. At the start of the game, each player character is placed in one section that is selected by any method. When this section has become “development completed”, each player character placed in this section is allowed to move to sections adjacent to this section. In the exemplary embodiment, one section is adjacent to four sections. Therefore, when one section has become “development completed”, four sections adjacent to this section are opened, and the player character can move to the four sections. Then, the player character further develops the adjacent sections, thereby progressing the game. In other embodiments, when a certain section has become “development completed”, eight sections around this section may be opened.

In the exemplary embodiment, an influence range based on an antenna object placed in a certain section is effective in this section, and does not have any influence on the other sections. That is, an influence range based on an antenna object placed in a certain section is set so as not to extend to adjacent sections. This reduces the risk of inconvenience that an action by a player character in a section that has not yet become “development completed” has an influence on the other sections.

In the exemplary embodiment, the information processing system changes the state of a unit area that is set in the undeveloped state, irreversibly to the developed state. That is, in the exemplary embodiment, a unit area that has once been set in the developed state is not returned to the undeveloped state. In the exemplary embodiment, the player character can move an antenna object that has been placed by itself, to another place. Even if the antenna object having been moved causes a unit area to be outside the influence range, the state of this unit area is not returned to the undeveloped state. This reduces the risk that the game progress is stagnated because the undeveloped state and the developed state are alternately repeated with respect to unit areas in a section and thereby this section is not readily set in the development completed state. In other embodiments, the information processing system may return the unit area in the developed state to the undeveloped state, based on a certain condition (e.g., according to an enemy character having performed a predetermined action).

In the exemplary embodiment, the information processing system updates an individual development value and a section development value in response to that the player character develops the game field (i.e., a unit area in the undeveloped state is changed to the developed state). FIG. 13 shows an example of a development state in one section. In FIG. 13, among the unit areas in the section, unit areas in the developed states are indicated by hatching. FIG. 13 shows a situation in which unit areas within a range enclosed by a dotted line have been newly changed to the developed states.

The individual development value is a parameter that is associated with each player (i.e., each player character) and is increased in response to that development is performed by the player character operated by the player (see FIG. 13). In the exemplary embodiment, the individual development value is increased according to the number of unit areas that have been changed to the developed states by the player character. The specific calculation method for an individual development value is discretionary. In the exemplary embodiment, the information processing system increases the individual development value by a magnitude according to the number of unit areas that have been newly set in the developed states by the player character. For example, if there are unit areas that are newly set in the developed states due to an antenna object placed by the player character, a value obtained by multiplying the number of the unit areas by a predetermined coefficient is added to the current individual development value. In other embodiments, the amount of increase in the individual development value may be calculated based on an area or a volume of the unit areas that are newly set in the developed states. As described above, the individual development value is a value according to the number of unit areas that are set in the developed states by the player character.

In the exemplary embodiment, a level is set on each player character, and the information processing system can raise the level of each player character in response to that the individual development value of the player character reaches a predetermined level threshold. For example, the level threshold may be a value that is a multiple of 100. Each time the individual development value becomes a multiple of 100, the player can raise the level of the player character by 1. Raising the level of the player character may be performed according to a predetermined level-up operation performed by the player, or may be automatically performed in response to that the individual development value reaches the predetermined level threshold. The individual development value may be calculated so as to be decreased by a degree required for level-up or may be calculated so as to be reset (i.e., returned to 0) in response to that the level of the player character is raised. The individual development value may be decreased during the game. For example, the individual development value may be decreased in response to the level-up as described above, or may be decreased in response to purchase of an item (i.e., in exchange for the purchased item). In this case, the information processing system may store, for each player, an accumulated individual development value that the player has acquired up to the present, in addition to the current individual development value.

A reward on the game may be given to the player according to the level of the player character. For example, in response to that the level of the player character is raised, the information processing system may change the appearance of the player character, or may provide the player character with an item (e.g., costume or equipment) that changes the appearance of the player character. Moreover, for example, the information processing system may allow the player character to enter a specific area in the game field, on the condition that the level of the player character is a predetermined level or higher. These rewards are given based on the level that is raised according to the individual development value, and therefore can be regarded as an example of rewards that are given based on the individual development value.

In the exemplary embodiment, based on the individual development value, the information processing system gives the reward on the game to a player corresponding to the individual development value (in other words, gives the reward on the game to the player character corresponding to the player). In the following description, the reward that is given based on the individual development value is referred to as an individual reward. The individual reward can motivate the player to progress the game by developing the game field. In the exemplary embodiment, each time the level of the player character is raised, the information processing system gives the individual reward according to the level to the player. Thus, the individual reward can be given to the player according to an increase in the individual development value.

The individual reward may be any game element that is usable in the game. In the exemplary embodiment, the information processing system gives, to the player, as the individual reward, a right to acquire a support item with which the player character can efficiently edit the game field (specifically, a design drawing described later). Examples of the support item include a machine capable of moving many pieces together, and a vehicle with which the player character can move in the game field at a high speed. Such a support item usable for developing the game field being given as the individual reward, more strongly motivates the player to develop the game field.

In the exemplary embodiment, the information processing system gives, as the individual reward, a design drawing of a support item to the player character. Using the design drawing, the player character can generate a support item corresponding to the design drawing. The design drawing may enable the player character to generate the support item each time the player character acquires the design drawing (i.e., the player character can generate the support item any number of times), may enable the player character to generate the support item on the condition that the player character owns the design drawing, or may enable the player character to generate the support item within a limit of a predetermined number of times. In the exemplary embodiment, as the right to acquire the support item, an item, i.e., the design drawing, is given to the player character. In other embodiments, as the right to acquire the support item, an ability to generate the support item may be given to the player character. In the exemplary embodiment, the player character that has acquired the design drawing can generate the support item by consuming an item that can be obtained during the game, or by updating the parameter in the game. Specifically, the player character can generate the support item by using (i.e., by consuming) a material item that can be obtained during the game, or by consuming the energy.

In the exemplary embodiment, a plurality of types of design drawings are prepared, and the information processing system gives a design drawing to the player character each time the level of the player character is raised. That is, in the exemplary embodiment, the player character acquires more types of design drawings and has the right to acquire more types of support items in the case where the level of the player character is high (i.e., the individual development value is large) than in the case where the level of the player character is low (i.e., the individual development value is small). In this regard, the larger the individual development value is, the easier the game can be progressed. Therefore, it is possible to more strongly motivate the player to develop the game field in order to increase the individual development value. The number of design drawings to be given when the level of the player character has been raised is discretionary. For example, in other embodiments, the number of design drawings to be given may be two or more, or may be zero. The number of design drawings to be given may vary depending on the level at the time of level-up. For example, the number of design drawings to be given when the player character is raised to the first level may be two or more, and the number of design drawings to be given when the player character is raised to the second level may be zero.

The item to be given as the individual reward is not limited to the design drawing of the support item, and any types of items may be given. For example, in other embodiments, the support item itself may be given as the individual reward to the player character. The individual reward being given can motivate the player to progress the game, regardless of the content of the item given as the individual reward.

The individual reward includes not only the reward regarding the item described above, but also enhancing the ability or the state of the player character. In the exemplary embodiment, the information processing system may give energy to perform the special action as the individual reward to the player character, or may perform, as the individual reward, a process of enhancing the level and/or the ability value of the player character. Also, the individual reward may be a currency in the game, or points usable in the game.

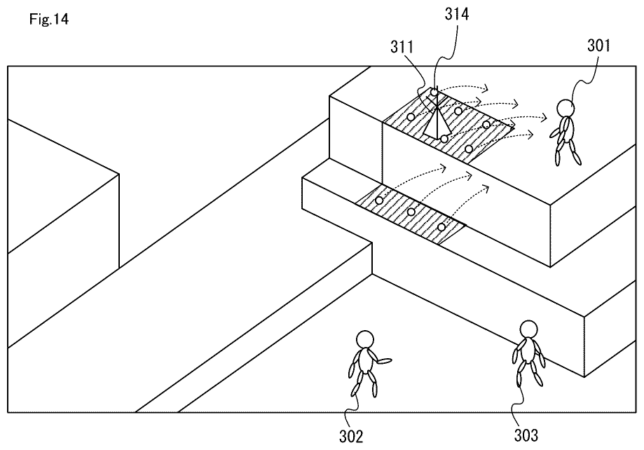

In the exemplary embodiment, when development of the game field has been performed, the game system 1 changes the display mode of the game field with respect to the unit areas in the developed part. FIG. 14 shows an example of a game image after an antenna object has been placed. As shown in FIG. 14, in response to that an antenna object 311 is placed, the upper surface of the game field in a unit area where the antenna object 311 is placed and surrounding unit areas is displayed with an appearance representing “developed” (by hatching in FIG. 14). For example, in the exemplary embodiment, the upper surface of the game field in the unit areas in the undeveloped states is displayed with an appearance representing wasteland, and the upper surface of the game field in the unit areas in the developed states is displayed with an appearance representing lawn. Thus, the game field is displayed so as to have different appearances depending on the states of the unit areas, whereby the developed part of the game field can be presented to the player in an easily understandable manner.

In the exemplary embodiment, the information processing system sets a base area on the upper surface of each of the pieces constituting the game field, and changes the display mode of the base area to change the display mode of the game field. Here, the base area is an area disposed on the upper surface of each piece, and is displayed to be visible unlike a unit area. Thus, the upper surface of the game field has an appearance of the base area disposed on the upper surface of each of the pieces constituting the game field. In the exemplary embodiment, the appearance of the base area depends on the state (i.e., developed or undeveloped) of a unit area corresponding to the base area. Specifically, if the unit area is in the developed state, the appearance of the base area in this unit area is set to the appearance representing lawn. If the unit area is in the undeveloped state, the appearance of the base area in this unit area is set to the appearance representing wasteland. Thus, the appearance of the upper surface of the game field can be set to the appearance according to the state of the unit area. The base area may be set on the upper surface of each of the pieces constituting the game field, or may be set on, among the pieces, only pieces constituting the upper surface of the game field (i.e., pieces on which other pieces are not disposed).

In other embodiments, the information processing system may place a plurality of types of pieces having different appearances. In this case, a base area may be set for a predetermined type of pieces, and a base area may not be set for the other types of pieces. In this case, the appearance of the upper surface of the game field constituted by the predetermined type of pieces is changed according to the state of the corresponding unit area, and the appearance of the upper surface of the game field constituted by the other types of pieces is not changed according to the state of the corresponding unit area.

The specific method for changing the display mode (i.e., appearance) of the game field is discretionary, and is not limited to the method using the base area. For example, in other embodiments, the information processing system may change the appearance of a piece itself according to the state of the corresponding unit area, without setting a base area.

In FIG. 14, for the sake of viewability of the drawing, only nine unit areas including the unit area in which the antenna object 311 is placed and the surrounding unit areas are changed to the developed states. However, in actuality, unit areas within a larger influence range may be changed to the developed states. In the example shown in FIG. 14, in response to that the state of a unit area is changed to the developed state, the appearance of only a part of the upper surface of the game field (i.e., piece) in the unit area is changed. However, in other embodiments, the appearance of a part, other than the upper surface, of the game field may be changed as well.

In other embodiments, the game system 1 may display the game image such that the area having the appearance indicating “developed” gradually spreads from the unit area where the antenna object is placed, toward the periphery. That is, when the antenna object has been placed, the appearance of the game field in the unit area where the antenna object is placed is firstly changed, and next, the appearance of the game field in the unit areas adjacent to the unit area is changed. Finally, the appearance of the game field in all the unit areas within the influence range is changed.

In the exemplary embodiment, when a unit area is changed from the undeveloped state to the developed state, the game system 1 displays an effect image (e.g., effect image 314 shown in FIG. 14) in association with this unit area. In the example shown in FIG. 14, each effect image looks like a circular particle. In the exemplary embodiment, effect images 314 are displayed such that they are generated in the unit areas changed to the developed states and thereafter move toward the player character that has developed the unit areas (i.e., the player character 301 that has placed the antenna object 311) (see dotted-line arrows shown in FIG. 14). Thus, in response to that the unit areas are changed from the undeveloped states to the developed states, the game system 1 displays the effect images corresponding to the number of the changed unit areas such that the effect images move from the positions of the unit areas toward the player character. This allows the player to be notified of the number of the unit areas having been changed to the developed states, and allows the player to be notified of the player character having performed the development.

As described above, in the exemplary embodiment, when the player character has developed the game field, the information processing system increases the individual development value of the player corresponding to the player character. In other embodiments, in addition to the case where the player character has developed the game field, even when another player character has developed the game field, the individual development value corresponding to the player character may be increased. In this case, the chances of increasing the individual development value can be increased, thereby enhancing the motivation of each player to progress the game.

For example, if unit areas located within a predetermined range based on a player character corresponding to a player are developed by another player character, the information processing system may update the individual development value associated with this player, based on the number of the developed unit areas. Here, in this game, if another player character present near a certain player character develops the game field by placing an antenna object, it is conceivable that the certain player character was helping the another player character. For example, it is conceivable that the certain player character and the another player character edit the game field in cooperation with each other so as to place the antenna object at a higher position, and thereafter, the another player character actually places the antenna object. In such a case, since the development of the game field can be regarded to be performed by the two player characters in cooperation, not only the another player character but also the certain player character are given the individual development values, thereby reducing the risk that the players feel unfair.

The information processing system may set the amount of increase in the individual development value corresponding to the another player character that actually places the antenna object to be larger than the amount of increase in the individual development value of the certain player character that is present near the another player character. For example, the amount of increase for the latter may be determined by multiplying the amount of increase for the former by a coefficient according to the distance between the player characters (specifically, a coefficient less than 1). In addition, the amount of increase for the latter may be set to be larger as the position of the certain player character is closer to the unit area that has been developed by the another player character. In other embodiments, the amount of increase for the former may be the same as that for the latter.

Next, a section development value will be described. The section development value is a parameter that is associated with each section and is increased in response to that development is performed for the section (see FIG. 13). The section development value is increased according to the number of unit areas that are changed to the developed sates in the section. The information processing system updates the section development value associated with the section including unit areas having been changed from the undeveloped states to the developed states. The specific calculation method for the section development value is discretionary. For example, if there are unit areas that have been newly changed to the developed states in the section, a value obtained by multiplying the number of the unit areas by a predetermined coefficient is added to the current section development value. Thus, the section development value is a value according the number of unit areas having been changed to the developed states among the unit areas in the section.

In the exemplary embodiment, if the section development value satisfies a predetermined release condition, the information processing system allows execution of a process regarding the corresponding section. Specifically, if the section development value does not satisfy the predetermined release condition, the information processing system restricts execution of the process regarding the corresponding section. If the section development value satisfies the predetermined release condition, the information processing device releases the restriction on execution of the process. This motivates the player to progress development in the section.

In the exemplary embodiment, the “process regarding a section” is a process of moving the player character to other sections adjacent to this section. That is, in response to that the section development value satisfies the release condition, the information processing system allows each player character placed in the section to move to the sections adjacent to this section (in other words, the information processing system opens the adjacent sections). In the exemplary embodiment, since one section has four adjacent sections (see FIG. 12), if the section development value satisfies the release condition, the player character can move to four new sections. According to the above, the player can move the player character to another section by progressing development of the section where the player character is currently placed. This motivates the player to progress development of the section. In the exemplary embodiment, no restriction is imposed on movement to a section for which the release condition is satisfied, from another section. That is, the player character can freely move between a section for which the release condition is satisfied, and a section which is adjacent to this section and for which the release condition is not satisfied. The process of restricting movement of the player character to a section may be a process of inhibiting the player character from moving to the section, or a process of limiting movement of the player character in the section in some way (e.g., reducing the movement speed).

In other embodiments, the “process regarding a section” may have any content, and is not limited to the process of moving the player character to adjacent sections. Although described in detail later, in the exemplary embodiment, a section for which the release condition is satisfied is given a name by the player. The process of giving such a name can also be regarded as an example of the “process regarding a section”. For example, in other embodiments, as the process regarding a section, the information processing system may perform a process of reducing energy consumption by the aforementioned special action. That is, in response to that the section development value satisfies the release condition, the information processing system may reduce the energy to be consumed by the special action of the player character in the section.

In the exemplary embodiment, the information processing system executes a process of changing the brightness of the game field in a section, based on the section development value of the section. Specifically, the game field in the section is displayed to be brighter according to the section development value of the section (specifically, as the section development value is larger). In the exemplary embodiment, the information processing system controls the brightness of the section so that the brightness becomes maximum when the section development value has satisfied the release condition. That is, the brightness of section gradually increases with an increase in the section development value until the section development value satisfies the release condition. After the section development value has satisfied the release condition, the brightness of the section is maintained constant (specifically, at the maximum value of brightness).

In the exemplary embodiment, when the section development value regarding a section has satisfied the release condition, the information processing system treats this section as a section for which development has been completed (e.g., turns on a flag indicating completion of development for this section). In the exemplary embodiment, after development of a section has been completed (i.e., after the section development value has satisfied the release condition), the individual development value and the section development value are not increased even if an undeveloped unit area in this section is changed to the developed state. However, in other embodiments, even after the section development value regarding a section has satisfied the release condition, the information processing system may increase the individual development value and the section development value in response to that an undeveloped unit area is changed to the developed state, as in the case where the release condition is not yet satisfied.

In other embodiments, when the section development value regarding a section has satisfied the release condition, the information processing system may change all the unit areas in the undeveloped states in this section to the developed states. That is, when the section development value has satisfied the release condition, all the unit areas in the section are in the developed states. Thus, all the unit areas in the section are developed in response to the release condition being satisfied, whereby the game can be smoothly progressed.

In the exemplary embodiment, the release condition is that the section development value reaches a predetermined open value. More specifically, the open value is a value equal to a section development value in the case where half the unit areas included in the section are in the developed states. Thus, in response to that half the unit areas in the section are changed to the developed states, the release condition is satisfied and development of the section is completed. Thus, the game can be smoothly progressed. The release condition may have any content. For example, in other embodiments, the release condition may be that a predetermined percentage of unit areas in the section are changed to the developed states.

In the exemplary embodiment, in a situation where development has progressed in a section and most of unit areas in this section are in the developed states, searching for remaining unit areas in the undeveloped states requires much labor. In addition, since such remaining unit areas in the undeveloped states are arranged at random, it is difficult to change many unit areas to the developed states by placement of one antenna object. That is, as development progresses in the section, development of unit areas that remain undeveloped becomes difficult. Therefore, in the exemplary embodiment, as development progresses in a section, the information processing system increases the amount of increase with respect to the individual development value of the player character that has performed the development. That is, the information processing system sets a larger amount of increase for the individual development value to be increased in response to that a unit area is changed from the undeveloped state to the developed state, in the case where the number of unit areas in the developed states is large in the section, than in the case where the number of unit areas in the developed states is small in the section. For example, the amount of increase in the individual development value in the case where the development percentage in the section (specifically, the amount of increase for development of one unit area) is 25% to 50%, is set to be larger than in the case where the development percentage in the section is 0% to 25%. Thus, even in the situation where development has been progressed in a section, it is possible to motivate the player to develop this section.

In the exemplary embodiment, as in the case of the individual development value, also for the section development value, the information processing system sets a larger amount of increase for the section development value to be increased in response to that a unit area is changed from the undeveloped state to the developed state, in the case where the number of unit areas in the developed states is large in the section, than in the case where the number of unit areas in the developed states is small in the section. For example, the amount of increase in the section development value in the case where the development percentage in the section (specifically, the amount of increase for development of one unit area) is 25% to 50%, is set to be larger than in the case where the development percentage in the section is 0% to 25%. Thus, even in the situation where development has been progressed in a section, it is possible to motivate the player to develop this section.

In the exemplary embodiment, the information processing system performs, as a process based on a section development value, a process of giving a reward on the game to a player corresponding to a player character in the corresponding section. Hereinafter, a reward to be given based on the section development value is referred to as a section reward. In the exemplary embodiment, when a predetermined granting condition regarding a section development value has been satisfied due to update of the section development value, the information processing system gives a section reward to a player corresponding to a player character having placed an antenna object that is a cause of the update. In the exemplary embodiment, the granting condition has the same content as the release condition. That is, when the section development value has satisfied the release condition through development by a certain player character, the information processing system gives a section reward to the certain player character.

In the exemplary embodiment, the section reward is a right to give a name to a section for which the release condition is satisfied. In the exemplary embodiment, a name is given to a section for which the release condition is satisfied and development is completed. This name is determined by the player corresponding to the player character having performed the development that is a factor satisfying the release condition. The section reward can also motivate the player to progress the game by developing the section. The section reward may have any content. In other embodiments, the section reward may be an item such as a design drawing described above, a currency in the game, or points usable in the game. The granting condition may have any content, and may not necessarily be the same as the release condition. For example, the granting condition may have the same content as a presentation condition described later. For example, the granting condition may be that a player to be given a section reward has acquired a section development value equal to or larger than a predetermined value, or may be that a player to be given a section reward has acquired the largest section development value before the section becomes “development completed”, among the player characters located in the section.

In the exemplary embodiment, as a process based on a section development value, the information processing system executes a process of placing an object inscribed with a player's name (e.g., a stele) in the game field when the section development value has satisfied a predetermined presentation condition. In the exemplary embodiment, the presentation condition is that the section development value is a multiple of 1000, or that the release condition is satisfied. That is, when the section development value has satisfied the presentation condition through development by a certain player character, an object inscribed with the name of the player corresponding to the certain player character is placed in the game field. The object may be disposed in any place. The place may be determined in advance, or specified by the player character. This also motivate the player to progress the game by developing the section. Only one stele object may be placed in one section, and the names of players corresponding to a plurality of player characters that have satisfied the presentation condition with respect to the section may be inscribed in the one stele object. In this case, if the presentation condition is newly satisfied in the state where a stele object is already placed with respect to a certain section, the name of the corresponding player is additionally inscribed to the already placed stele object.

If the presentation condition is satisfied as a result of a unit area having been changed to the developed state, the information processing system may display the effect image (see FIG. 14) to be displayed for this unit area, in a display mode different from that for the effect image to be displayed in the case where the presentation condition is not satisfied as the result of the unit area having been changed to the developed state. For example, the color, size, etc., of the former effect image may be different from those of the latter effect image. This allows the player to be notified that the presentation condition is satisfied, in a more easily understandable manner.

In the exemplary embodiment, the game system 1 places, in the game field, the object inscribed with the name of the player who has satisfied the presentation condition. However, the specific method for presenting information on this player to the players of the game is not limited thereto. For example, in other embodiments, the game system 1 may present the information on the player who has satisfied the presentation condition, on a menu screen that can be displayed during the game. Moreover, in other embodiments, in addition to the name of the player, an icon representing the player and/or an icon of the player character may be presented as information on the player. The information on the player may not necessarily be presented to all the players participating in the game, and may be presented to at least one other player. The game system 1 may present, for example, information on a player who has satisfied the presentation condition with respect to a certain section, to players corresponding to player characters that are placed in this section at the time when the presentation condition has been satisfied.

As described above, in the exemplary embodiment, unit areas within an influence range are set in the developed states in principle. However, if a predetermined restrictive object is placed in the game field, the information processing system restricts unit areas within a predetermined restrictive range based on the restrictive object from being changed to the developed states. That is, the unit areas in the restrictive range are maintained in the undeveloped states even if an antenna object is placed and thereby the unit areas are located in the influence range. This enhances the strategic characteristics of the game, and enhances the entertainment characteristics of the game. The restrictive range may have any size and any shape. For example, the restrictive range may have the same shape as the restrictive object, or a columnar shape centering around the position of the restrictive object. The player character may place another object on the restrictive object so that the restrictive object is destroyed and the another object is placed at the position where the restrictive object was present. The player character may be able to destroy the restrictive object with a predetermined action (e.g., an action of attacking the restrictive object), or may be able to move the restrictive object. In other embodiments, the restrictive object may not necessarily be placed in the game field.

### 4. Specific Example of Processing in Information Processing System

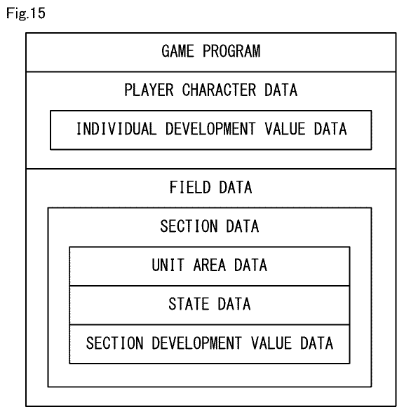

Next, a specific example of information processing in the information processing system will be described with reference to FIGS. 15 to 19.

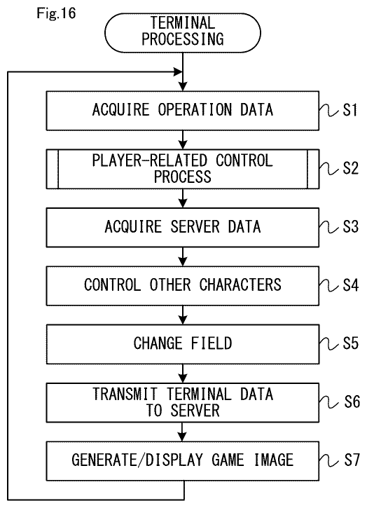

FIG. 15 shows an example of various data stored in the game system 1. As shown in FIG. 15, the game system 1 stores a game program therein. The game program is an information processing program on a terminal side (i.e., game system 1 side) for executing the game in the game system 1. The processor 81 of the game system 1 executes the game program, whereby terminal processing described later (see FIG. 16) is executed in the game system 1.

The game system 1 stores player character data in the memory. The player character data includes various data related to a player character corresponding to a player of the game system 1. For example, the player character data includes data indicating the position, attribute, level, possessed items, etc. of the player character. In the exemplary embodiment, the player character data includes individual development value data indicating an individual development value associated with the player character. At the start of the game, the individual development value data indicates 0. The memory may be any memory accessible to the game system 1, and is the DRAM 85, for example.

The game system 1 stores field data in the memory. The field data includes various data related to the game field. In the exemplary embodiment, the field data includes section data regarding sections set in the game field. The section data is stored for each section. In the game system 1, section data of the respective sections in the game field may be stored, or only section data of some sections (e.g., a section where a player character is placed and sections adjacent to this section) among the sections in the game field, may be stored.

The section data includes unit area data, state data, and section development value data. The unit area data indicates the state (i.e., the undeveloped state or the developed state) of each unit area included in the section. The state data indicates the state of the section (i.e., whether the section is in the development completed state, and whether the section is in the open state). The section development value data indicates a section development value associated with the section. The section data includes, in addition to the above data, data indicating the shape of the game field in the section, and data related to an object placed in the section (e.g., data indicating the position of an antenna object). At the start of the game, the unit area data indicates that each unit area in the section is in the undeveloped state. At the start of the game, the state data indicates that the section is in the development uncompleted state, and that the section is in the unopened state, excluding the section where the player character is placed. At the start of the game, the section development value data indicates 0.

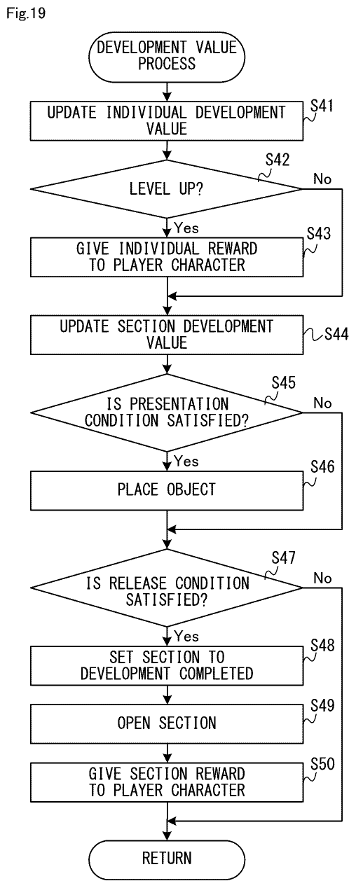

Although not illustrated, the server 201 stores therein a server program for executing the game. The server program is an information processing program on the server side for executing the game. The processing section 211 of the server 201 executes the server program, whereby server processing described later (see FIG. 19) is executed in the server 201.

The server 201 stores therein various data to be used for executing the game, such as the player character data and the field data described above. For example, the server 201 stores therein the player character data of the respective players participating in the game. In addition, the server 201 stores therein the field data including the section data of the respective sections in the game field. The various data to be used for executing the game may be stored in either one of the server 201 and the game system 1, or may be stored in both of them. If the same data is stored in the server 201 and the game system 1, synchronization between the data stored in the server 201 and the data stored in the game system 1 is made at an appropriate timing.

Next, a specific example of information processing performed by the game system 1 or the server 201 will be described with reference to FIGS. 16 to 19.

In the exemplary embodiment, the processor 81 of the main body apparatus 2 executes the game program stored in the game system 1, thereby executing processes in steps shown in FIGS. 16 to 18. In addition, the processor (i.e., the processing section 211) of the server 201 executes the server program stored in the server 201, thereby executing processes in steps shown in FIG. 19. However, in other embodiments, some of the processes in the steps may be executed by a processor (e.g., a dedicated circuit or the like) other than the processor. Some of the processes in the steps to be executed in the game system 1 may be executed in the server 201, or some of the processes in the steps to be executed in the server 201 may be executed in the game system 1. The processes in the steps shown in FIGS. 16 to 19 are merely examples, and the processing order of the steps may be changed or another process may be executed in addition to (or instead of) the processes in the steps as long as similar results can be obtained.

The processor of the game system 1 or the server 201 executes the processes in the steps shown in FIGS. 16 to 19 by using a memory (e.g., the DRAM 85 or the storage section 212). That is, the processor stores information (in other words, data) obtained through each process step into the memory, and reads out the information from the memory when using the information for the subsequent process steps.

FIG. 16 is a flowchart showing an example of a flow of terminal processing executed by the game system 1. The terminal processing shown in FIG. 16 is started in response to that an instruction to start the game is performed by a player during execution of the game program.

In step S1 shown in FIG. 16, the processor 81 acquires the operation data indicating an operation input performed by the player. That is, the processor 81 acquires the operation data received from the controllers via the controller communication section 83 and/or the terminals 17 and 21. Next to step S1, the process in step S2 is executed.

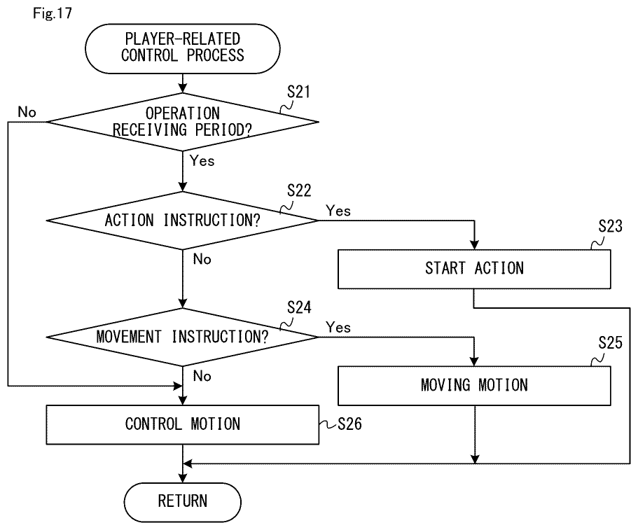

In step S2, the processor 81 performs a player-related control process. In the player-related control process, a control process related to a player character is executed based on an operation input performed by the player. Hereinafter, the player-related control process will be described in detail with reference to FIG. 17.

FIG. 17 is a sub-flowchart showing an example of a specific flow of the player-related control process in step S2 shown in FIG. 16. In the player-related control process, firstly, in step S21, the processor 81 determines whether or not it is an operation receiving period during which an operation input for the player character is received. In the exemplary embodiment, a period during which the player character is performing a predetermined action (e.g., an action to be started in step S23 described later) according to an operation input performed by the player, is executed from the operation receiving period. When the determination result in step S21 is positive, the process in step S22 is executed. When the determination result in step S21 is negative, the process in step S26 described later is executed.

In step S22, the processor 81 determines whether or not an operation input for an action instruction to the player character has been performed, based on the operation data acquired in step S1. The action instruction is an instruction that causes the player character to perform, for example, an action of placing an antenna object, an action of lifting a piece, the aforementioned special action, etc. When the determination result in step S22 is positive, the process in step S23 is executed. When the determination result in step S22 is negative, the process in step S24 is executed.

In step S23, the processor 81 causes the player character to start the action according to the action instruction performed in step S22. After the player character has started the action in step S23, the player character is controlled in the process in step S26 described later so as to perform the action for a predetermined period. After step S23, the processor 81 ends the player-related control process shown in FIG. 16.

In step S24, the processor 81 determines whether or not an operation input for movement instruction to the player character has been performed, based on the operation data acquired in step S1. The movement instruction is an instruction that causes the player character to move on the game field. When the determination result in step S24 is positive, the process in step S25 is executed. When the determination result in step S24 is negative, the process in step S26 is executed.

In step S25, the processor 81 causes the player character to perform a motion of moving on the game field, according to the movement instruction performed in step S24. After step S25, the processor 81 ends the player-related control process shown in FIG. 17.

In step S26, the processor 81 controls the player character so that the player character performs various motions, such as a motion of progressing the action started in step S23, a motion in the case where there is no input by the player, etc. In one step S26, the processor 81 controls the player character so that the player character progresses the motion for one frame time. The process in step S26 being repeatedly executed over a plurality of frames allows the player character to perform a series of motions according to the action instruction.

If a motion that the player character should perform is not instructed by the player (e.g., if the motion started in step S23 has already been ended), in step S26, the processor 81 may not necessarily cause the player character to perform a motion, or may cause the player character to perform a motion that makes the behavior of the player character natural (e.g., a motion of looking around, or rocking the body). After step S26, the processor 81 ends the player-related control process shown in FIG. 17. The player-related control process is followed by the process in step S3 shown in FIG. 16.

Referring back to FIG. 16, in step S3, the processor 81 acquires server data from the server 201. The server data includes data that can specify an individual development value, a reward, and a section development value related to the player character corresponding to the player of the game system 1. In addition, the server data includes data that can specify the behavior of another player character different from the player character (e.g., the position, attribute, state, etc., of the another player character). This data is, for example, data indicating an operation to the another player character, or data indicating the behavior of the another player character. The server data is data that can specify the situation of the game field (e.g., the shape of the game field, the states of unit areas and sections, etc.). This data may include, for example, data indicating the situation in the section where the player character corresponding to the game system 1 is placed, or may include data indicating a change in the section (e.g., data indicating movement of a piece when the piece is moved, or data indicating the state of a unit area when the state is changed). In step S3, the processor 81 transmits an acquisition request indicating acquisition of the server data to the server 201 by using the network communication section 82. Although details will be described later, upon receiving the acquisition request from the game system 1, the server 201 transmits the server data to the game system. The processor 81 acquires the server data transmitted from the server 201 by receiving the same with the network communication section 82. Next to step S3, the process in step S4 is executed.

In step S4, the processor 81 controls the motion of another player character, based on the server data acquired in step S3. In one step S4, the processor 81 controls the another player character to progress the motion for one frame time. In step S4, the processor 81 need not perform the motion control for all the other player characters on the game field. For example, the processor 81 may perform the motion control for only other player characters placed in a field-of-view range of a virtual camera for generating a game image. Next to step S4, the process in step S5 is executed.

In step S5, the processor 81 adds a change in the game field, based on the motion of each player character in steps S2 and S4. For example, if the player character performs a motion of moving a piece in the process in step S2 or S4, the processor 81 changes the game field so that the game field has the shape after the movement of the piece. For example, if the player character performs an action of placing an object in the process in step S2 or S4, the processor 81 places the object in the game field. For example, if the server data indicating that the game field has been changed is acquired in the process in step S33, the processor 81 changes the game field, based on the server data. The processor 81 updates the field data stored in the memory so that the field data indicates the game field after the change. Next to step S5, the process in step S6 is executed.

In step S6, the processor 81 transmits terminal data to the server 201. The terminal data is data related to the motion of the player character corresponding to the player of the game system 1. For example, the terminal data includes data indicating the processing result in step S2 (i.e., data indicating the motion regarding the player character corresponding to the player of the game system 1). Alternatively, the terminal data may be the operation data acquired in step S1. The processor 81 generates such terminal data, and transmits the generated terminal data to the server 201 by using the network communication section 82. Next to step S6, the process in step S7 is executed.

In step S7, the processor 81 generates a game image, and displays the game image on the display 12. Specifically, in the game field, the processor 81 sets the virtual camera such that the player character corresponding to the player of the game system 1 is included in the field-of-view range, and performs a rendering process based on the virtual camera to generate a game image indicating a game space. Thus, the game image showing the behavior of each player character and the situation in the game field, updated in steps S2, S4, and S5, is displayed. If a unit area is changed to the developed state, the processor 81 generates a game image so that the game image includes the aforementioned effect image at the position of the unit area. Moreover, in the process in step S7 executed thereafter, the processor 81 generates a game image so that the effect image gradually moves toward the player character.

Next to step S7, the process in step S1 is executed again. Thereafter, during the game, a series of processes in steps S1 to S7 is repeatedly executed. The terminal processing shown in FIG. 16 is ended when an instruction to end the game has been made by the player, or when a condition to end the game has been satisfied.

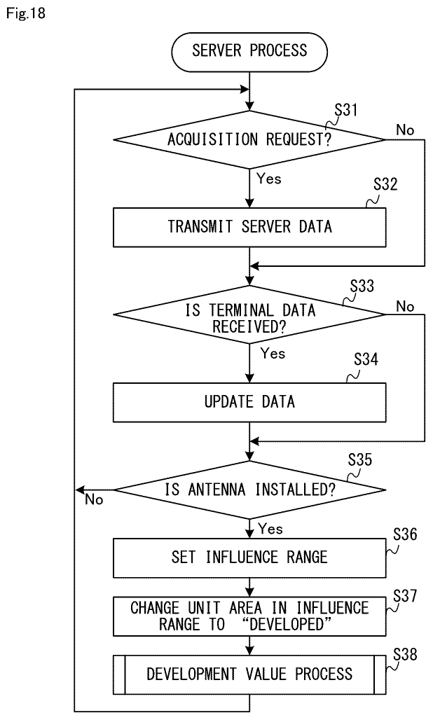

FIG. 18 is a flowchart showing an example of a flow of server processing executed by the server 201. A series of processes shown in FIG. 18 is consecutively executed while the server 201 is operated.

In step S31 shown in FIG. 18, the processing section 211 determines whether or not the aforementioned acquisition request (see step S3 in FIG. 16) is received from the game system via the communication section 213. When the determination result in step S31 is positive, the process in step S32 is executed. When the determination result in step S31 is negative, the process in step S32 is skipped, and the process in step S33 is executed.

In step S32, the processing section 211 transmits the server data to the game system that has transmitted the acquisition request. That is, the processing section 211 generates server data, based on the player character data and the field data stored in the storage section 212, and transmits the server data to the game system by using the communication section 213. Next to step S32, the process in step S33 is executed.

In step S33, the processing section 211 determines whether or not terminal data is received from the game system. In the exemplary embodiment, the server 201 receives terminal data from each of the game systems used by the players participating in the game. When the determination result in step S33 is positive, the process in step S34 is executed. When the determination result in step S33 is negative, the process in step S34 is skipped, and the process in step S35 is executed.

In step S34, the processing section 211 updates the player character data and the field data stored in the storage section 212, based on the terminal data received from the game system. Thus, the player character data and the field data stored in the storage section 212 are updated so as to reflect the game situation in each game system. Next to step S34, the process in step S35 is executed.

In step S35, the processing section 211 determines whether or not an antenna object is placed in the game field in step S34. When the determination result in step S35 is positive, the process in step S36 is executed. When the determination result in step S35 is negative, the processes in steps S36 to S38 are skipped, and the process in step S31 is executed again.

In step S36, the processing section 211 sets an influence range for the placed antenna object. That is, the processing section 211 sets the influence range in the game field, based on the position of the antenna object. Next to step S36, the process in step S37 is executed.

In step S37, the processing section 211 sets unit areas in the influence range set in step S36 to the developed states. Specifically, the processing section 211 updates the unit area data stored in the storage section 212 so that the unit area data indicates that the unit areas in the influence range are in the developed states. Next to step S37, the process in step S38 is executed.

In step S38, the processing section 211 executes a development value process. In the development value process, the individual development value and the section development value are updated, and a reward is given based on the update. Hereinafter, the player-related control process will be described in detail with reference to FIG. 19.

FIG. 19 is a sub-flowchart showing an example of a specific flow of the development value process in step S38 shown in FIG. 18. In step S41, the processing section 211 updates the individual development value of the player character that has placed an antenna object. Specifically, the processing section 211 calculates an amount of increase in the individual development value, based on the number of unit areas that have been newly changed to the developed states in step S37. The specific calculation method for the amount of increase is described in the above “[3. Outline of processing in information processing system]”. Furthermore, the processing section 211 increases the individual development value indicated by the individual development value data stored in the storage section 212, by the calculated amount of increase, and updates the individual development value data so that the data indicates the increased individual development value. Next to step S41, the process in step S42 is executed.

In step S42, the processing section 211 determines whether or not the level of the player character is raised due to the update of the individual development value in step S41. That is, the processing section 211 determines whether or not the updated individual development value reaches a level threshold. When the determination result in step S42 is positive, the process in step S43 is executed. When the determination result in step S42 is negative, the process in step S43 is skipped, and the process in step S44 is executed.

In step S43, the processing section 211 raises the level of the player character, and gives an individual reward according to the raised level to the player character. That is, the processing section 211 updates the player character data stored in the storage section 212 so that the data indicates the raised level, and the state after the grant of the individual reward. Next to step S43, the process in step S44 is executed.

In the examples shown in FIG. 18 and FIG. 19, the level of the player character is automatically raised in response to that the individual development value reaches the level threshold. Here, as described above, the level of the player character may be raised according to a level-up operation performed by the player. In this case, instead of executing steps S42 and S43 during the development value process shown in FIG. 19, the processing section 211 may execute a determination process as to whether or not the level of the player character should be raised, and a process of raising the level of the player character if the determination result is positive, during the server process shown in FIG. 18. For example, during the server process, the processing section 211 may execute the above determination process regardless of the result of the determination process in step S35, and may execute the same process as step S43 if the determination result is positive.

In step S44, the processing section 211 updates the section development value. Specifically, the processing section 211 calculates an amount of increase in the section development value, based on the number of the unit areas having been newly changed to the developed states in step S37. The specific calculation method for the amount of increase is described in the above “[3. Outline of processing in information processing system]”. Furthermore, the processing section 211 increases the section development value indicated by the section development value data stored in the storage section 212 by the calculated amount of increase, and updates the section development value data so that the data indicates the increased section development value. Next to step S44, the process in step S45 is executed.

In step S45, the processing section 211 determines whether or not the section development value updated in step S44 satisfies the aforementioned presentation condition. When the determination result in step S45 is positive, the process in step S46 is executed. When the determination result in step S45 is negative, the process in step S46 is skipped, and the process in step S47 is executed.

In step S46, the processing section 211 places an object inscribed with the name of the player character in the game field. The processing section 211 updates the field data stored in the storage section 212 so that the data indicates the game field in which the object is placed. As described above, the number of objects to be placed in one section may be one. In this case, in step S46, if the object is not placed in the section, the processing section 211 may place the object. If the object is placed in the section, the processing section 211 may execute a process of changing the appearance of the object so that the name of the player character is additionally inscribed. Next to step S46, the process in step S47 is executed.

In step S47, the processing section 211 determines whether or not the section development value updated in step S44 satisfies the aforementioned presentation condition. When the determination result in step S47 is positive, the process in step S48 is executed. When the determination result in step S47 is negative, the processing section 211 ends the development value process.

In step S48, the processing section 211 sets the section whose section development value has been updated in step S44, to the development completed state. That is, the processing section 211 sets all the unit areas in the section to the developed states. In this case, the unit area data stored in the storage section 212 is updated so that all the unit areas in the section are in the developed states. In addition, the state data stored in the storage section 212 is updated so as to indicate “development completed”. Next to step S46, the process in step S47 is executed.

In step S49, the processing section 211 opens the sections adjacent to the section whose section development value has been updated in step S44. That is, the processing section 211 releases restriction so that the player character placed in the section can move to the adjacent sections. In this case, the section data regarding the adjacent sections, which is stored in the storage section 212, is updated so as to indicate the opened state. Next to step S49, the process in step S50 is executed.

In step S50, the processing section 211 gives a section reward to the player character. The player character to which the section reward is given is the player character having placed the antenna object that is a cause of the update of the section development value in step S44. In the exemplary embodiment, since the granting condition is the same as the release condition, if the determination result in step S47 is positive, the section reward is given in step S50. After step S50, the processing section 211 ends the development value process.

In the exemplary embodiment, the section reward is a right to give a name to the section for which the release condition is satisfied. That is, the game system corresponding to the player who is given the section reward receives an input of the name of the section, and determines the name of the section, based on an operation input performed by the player. Data indicating the determined name is added to the terminal data to be transmitted to the server 201. Upon receiving the terminal data through the process in step S33, the server 201 acquires the data indicating the determined name of the section. The processing section 211 updates the field data stored in the storage section 212, based on the acquired data. In addition, the processing section 211 generates server data based on the updated data, and transmits the generated server data to another game system different from the game system that has transmitted the terminal data. Thus, synchronization between the server 201 and each game system can be made with respect to the determined name of the section.

In other embodiments, the processes in steps S35 to S38 may be executed in each game system. For example, each game system executes the determination process in step S35 based on the processing results in steps S2 and S4. In addition, the game system adds data indicating the processing results in steps S37 and S38 to the terminal data to be transmitted to the server 201. Upon receiving the terminal data, the server 201 updates the field data stored in the storage section 212, based on the terminal data. The server 201 generates server data based on the updated data, and transmits the generated server data to another game system different from the game system that has transmitted the terminal data. Thus, synchronization between the server 201 and each game system can be made with respect to the state of the game field.

### 5. Function and Effect of Exemplary Embodiment, and Modifications

As described above, in the exemplary embodiment, the information processing system is configured to include the following means.
Character moving means that moves a player character corresponding to a player based on an operation input performed by the player, in a virtual game space in which a plurality of unit areas are set, each of the unit areas being set in either a first state or a second state (step S25).
Action execution means that causes the player character to perform a predetermined action, based on an operation input performed by the player (step S23).
State change means that, based on the predetermined action, changes the states of the unit areas set in the first state (e.g., undeveloped state) to the second state (e.g., developed state) among the unit areas specified by the predetermined action (step S37).
First parameter update means that updates a first parameter (e.g., an individual development value) associated with the player, based on the number of the unit areas that have been changed from the first state to the second state according to the predetermined action performed by the player character corresponding to the player (step S41).
Second parameter update means that updates a second parameter, based on the number of the unit areas that have been changed from the first state to the second state according to either the predetermined action performed by the player character, or the predetermined action performed by another player character corresponding to another player different from the player (step S44).
First process execution means that executes a first process based on the first parameter (step S43).
Second process execution means that executes a second process based on the second parameter (step S49).

According to the above configuration, the first parameter and the second parameter are updated in response to that the states of unit areas are changed. According to the above configuration, if a player does not actively change the states of unit areas, another player will change the states of the unit areas, and the number of unit areas whose states can be changed decreases. As a result, it becomes difficult for the player to change the states of unit areas, and update the first parameter. That is, in order for the player to frequently update the first parameter, the player need to change the states of unit areas by himself/herself before the states of many unit areas are changed by the another player. Thus, in the above configuration, the player aims for update of the first parameter while considering the states of unit areas having been changed by another player, whereby the strategic characteristics of the game can be enhanced. In addition, it is possible to cause each player to actively perform a game operation for changing the states of unit areas while updating the second parameter in cooperation with another player. As a result, the progress of the game is hardly stagnated, whereby the entertainment characteristics of the game can be enhanced.

In the above exemplary embodiment, the “unit areas” are areas obtained by dividing the game space into square lattices as viewed in the vertical direction, but the “unit areas” are not limited thereto. For example, the “unit areas” may be cubic areas arranged in three-axis directions orthogonal with each other in a three-dimensional game space. The game space may be a two-dimensional plane. In this case, the “unit areas” may be plane areas (e.g., square areas) set on the two-dimensional plane.

In the above exemplary embodiment, the “another player” is a player who uses a terminal different from the terminal (i.e., the game system 1) used by the player, but the “another player” is not limited thereto. The “another player” may include any other player participating in the game in the game space, and if an account is assigned to each player, may be another player whose account is different from that of the above player. The “another player” may use the same terminal as that of the above player such that, for example, the above player uses the left controller 3 of the game system 1 and the “another player” uses the right controller 4. Thus, a plurality of players may use a single game system.

In the above exemplary embodiment, the “first process” is a process of giving an individual reward to a player, but the “first process” is not limited thereto. For example, the first process may be any process that gives an advantage in the game to a player or a player character related to update of the first parameter. Likewise, in the above exemplary embodiment, the “second process” is a process of releasing restriction on movement to adjacent sections, but the “second process” is not limited thereto. For example, the second process may be any process that gives an advantage in the game to a plurality of player characters (e.g., player characters located in a section.

In the above exemplary embodiment, when a certain information processing device executes a process by using data (including a program), a part of the data required for the process may be transmitted from another information processing device different from the certain information processing device. In this case, the certain information processing device may execute the process by using the data received from the another information processing device and the data stored in itself.

In other embodiments, the information processing system may not necessarily include some of the components in the above exemplary embodiment, and may not necessarily execute some of the processes executed in the above exemplary embodiment. For example, in order to achieve a specific effect of a part of the above embodiment, the information processing system only needs to include a configuration for achieving the effect and execute a process for achieving the effect, and need not include other configurations and need not execute other processes.

The above exemplary embodiment can be used as, for example, a game system or a game program for the purpose of, for example, enhancing the strategic characteristics of the game.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing system comprising one or more processors that execute information processing, the information processing comprising:
causing a player character corresponding to a player to move based on an input performed by the player, in a virtual game space in which a plurality of unit areas are set, each unit area being set in either a first state or a second state;
causing the player character to perform a predetermined action, based on an input performed by the player;
according to the predetermined action, changing the states of the unit areas set in the first state to the second state, among the unit areas specified by the predetermined action;
updating a first parameter associated with the player, based on the number of the unit areas that have been changed from the first state to the second state according to the predetermined action performed by the player character corresponding to the player;
updating a second parameter, based on the number of the unit areas that have been changed from the first state to the second state according to either the predetermined action performed by the player character, or the predetermined action performed by another player character corresponding to another player different from the player;
executing a first process based on the first parameter; and
executing a second process based on the second parameter.

2. The information processing system according to claim 1, wherein
the first process is giving a first reward to the player, based on a value of the first parameter.

3. The information processing system according to claim 2, wherein
the first reward is a right for the player to acquire a predetermined item.

4. The information processing system according to claim 3, wherein
the first process is giving the right to the player such that more types of rights are given in a case where the value of the first parameter is large than in a case where the value of the first parameter is small.

5. The information processing system according to claim 1, wherein
the game space includes a plurality of sections,
each section includes a plurality of unit areas,
the second parameter is associated with each section, and
in updating the second parameter, the second parameter associated with the section including the unit areas having been changed from the first state to the second state is updated.

6. The information processing system according to claim 5, wherein
the information processing further comprises executing a third process related to the section, based on an input performed by the player, and
the second process is a process of restricting execution of the third process related to the section associated with the second parameter if the second parameter does not satisfy a release condition, and releasing the restriction on the execution of the third process if the second parameter satisfies the release condition.

7. The information processing system according to claim 6, wherein
the third process is a process of moving the player character to other sections adjacent to the section, and
the second process is a process of, based on the second parameter, releasing the restriction on the execution of the third process of moving the player character to other sections adjacent to the section associated with the second parameter.

8. The information processing system according to claim 7, wherein
the second process includes, if the second parameter satisfies the release condition, changing the unit areas in the first state, included in the section associated with the second parameter, to the second state.

9. The information processing system according to claim 7, wherein
the release condition is that the second parameter becomes a value at which more than half of the unit areas included in the section are in the second state.

10. The information processing system according to claim 5, wherein
updating the first parameter is an update in which, in response to that the unit areas have been changed from the first state to the second state according to the predetermined action, the first parameter is increased based on the number of the changed unit areas,
the first process is executed when the first parameter has reached a predetermined value, and
in updating the first parameter, an amount of increase in the first parameter in response to that the unit areas have been changed from the first state to the second state is larger in a case where the number of unit areas in the second state is large in the section than in a case where the number of unit areas in the second state is small in the section.

11. The information processing system according to claim 5, wherein
updating the second parameter is an update in which, in response to that the unit areas have been changed from the first state to the second state according to the predetermined action, the second parameter is increased based on the number of the changed unit areas,
the second process is executed when the second parameter has reached a predetermined value, and
in updating the second parameter, an amount of increase in the second parameter in response to that the unit areas have been changed from the first state to the second state is larger in a case where the number of unit areas in the second state is large in the section than in a case where the number of unit areas in the second state is small in the section.

12. The information processing system according to claim 1, wherein
changing the unit areas to the second state is changing the states of the unit areas being set in the first state, irreversibly to the second state.

13. The information processing system according to claim 1, wherein
updating the first parameter includes,
in a case where the unit areas located within a predetermined range based on the player character corresponding to the player are changed from the first state to the second state according to the predetermined action performed by the player character,
further updating the first parameter associated with the player.

14. The information processing system according to claim 13, wherein
updating the first parameter includes,
in a case where the unit areas located within the predetermined range based on the player character corresponding to the player are changed from the first state to the second state according to the predetermined action performed by the another player character,
updating the first parameter associated with the player, based on the number of the changed unit areas.

15. The information processing system according to claim 1, wherein
the information processing further includes, in response to that the unit areas have been changed from the first state to the second state, displaying images as many as the number of the changed unit areas such that the images move from the positions corresponding to the unit areas toward the player character.

16. The information processing system according to claim 1, wherein
the information processing further comprises, if a presentation condition related to the second parameter is satisfied by update of the second parameter, presenting, to the another player, information on the player corresponding to the player character having performed the predetermined action that is a cause of the update.

17. The information processing system according to claim 1, wherein
the information processing further comprises, if a granting condition related to the second parameter is satisfied by update of the second parameter, giving a second reward to the player corresponding to the player character having performed the predetermined action that is a cause of the update.

18. The information processing system according to claim 1, wherein
in changing the states of the unit areas to the second state, if the unit areas specified by the predetermined action are located within a range based on a position of a first object, changing the states of at least of a part of the unit areas to the second state is restricted.

19. The information processing system according to claim 1, wherein
the predetermined action is an action of the player character to place a second object in a unit area, and
changing the states of the unit areas to the second state is changing the unit areas within a predetermined range including the unit area in which the second object is placed, to the second state.

20. An information processing device comprising one or more processors that execute information processing, the information processing comprising:
in a virtual game space in which a plurality of unit areas are set, each unit area being set in either a first state or a second state, changing the states of the unit areas set in the first state to the second state, among the unit areas specified by a predetermined action, according to the predetermined action that is performed by a player character based on an input performed by the player;
updating a first parameter associated with the player, based on the number of the unit areas that have been changed from the first state to the second state according to the predetermined action performed by the player character;
updating a second parameter, based on the number of the unit areas that have been changed from the first state to the second state according to either the predetermined action performed by the player character, or the predetermined action performed by another player character corresponding to another player different from the player;
executing a first process based on the first parameter; and
executing a second process based on the second parameter.

21. One or more non-transitory computer-readable media having stored therein instructions that, when executed, cause one or more processors to execute an information processing comprising:
in a virtual game space in which a plurality of unit areas are set, each unit area being set in either a first state or a second state, changing the states of the unit areas set in the first state to the second state, among the unit areas specified by a predetermined action, according to the predetermined action that is performed by a player character based on an input performed by the player;
updating a first parameter associated with the player, based on the number of the unit areas that have been changed from the first state to the second state according to the predetermined action performed by the player character;
updating a second parameter, based on the number of the unit areas that have been changed from the first state to the second state according to either the predetermined action performed by the player character, or the predetermined action performed by another player character corresponding to another player different from the player;
executing a first process based on the first parameter; and
executing a second process based on the second parameter.

22. A game processing method executed by an information processing system, the information processing system executing:
in a virtual game space in which a plurality of unit areas are set, each unit area being set in either a first state or a second state, causing a player character corresponding to a player to move based on an input performed by the player;
causing the player character to perform a predetermined action, based on an input performed by the player;
according to the predetermined action, changing the states of the unit areas set in the first state to the second state, among the unit areas specified by the predetermined action;
updating a first parameter associated with the player, based on the number of the unit areas that have been changed from the first state to the second state according to the predetermined action performed by the player character corresponding to the player;
updating a second parameter, based on the number of the unit areas that have been changed from the first state to the second state according to either the predetermined action performed by the player character, or the predetermined action performed by another player character corresponding to another player different from the player;
executing a first process based on the first parameter; and
executing a second process based on the second parameter.
